(19) United States
(12) Patent Application Publication
(10) Pub. No.: US 2021/0366648 A1
(43) Pub. Date: Nov. 25, 2021

(54) A COIL ASSEMBLY FOR USE IN A COMMON MODE CHOKE

(71) Applicant: Tritium Pty Ltd., Murarrie (AU)

(72) Inventors: Bernard Brian Walsh, Milton (AU); James Mcfarlane Kennedy, Milton (AU)

(21) Appl. No.: 16/957,032

(22) PCT Filed: Dec. 20, 2018
(86) PCT No.: PCT/AU2018/051367

§ 371 Date: Jun. 22, 2020

(30) Foreign Application Priority Data
Dec. 22, 2017 (AU) 2017905167

(51) Int. Cl. H01F 27/28; H01F 27/32; H01F 27/12; H01F 37/00; H01F 41/00; H01F 27/33; H01F 41/063; H01F 27/30

(52) U.S. Cl. CPC H01F 27/2847; H01F 27/323; H01F 27/12; H01F 27/306; H01F 41/005; H01F 27/33; H01F 41/063; H01F 37/00

(57) ABSTRACT

A coil assembly including a plurality of substantially planar plates interconnected to define a plurality of electrically conductive windings for surrounding a magnetic core. In one example the invention is used for a magnetic core assembly, including a magnetic core and at least two coil assemblies, the coil assemblies each including a plurality of substantially planar plates interconnected to define a plurality of electrically conductive windings for surrounding the magnetic core.

### BACKGROUND OF THE INVENTION

The present invention relates to a coil assembly for use in a common mode choke, although more generally the coil assembly could be used with any type of inductor, transformer or power magnetic device.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Coil assemblies or windings form an integral part of power magnetic devices such as inductors or transformers. The windings carry an electrical current and as a result of being wound around a magnetic core, magnetise the core which results in magnetic flux flowing around the core. Typically, electrical windings are made from a wire conductor such as copper which is wound around the core. There are also edge wound windings in which an elongate strip of copper sheet is bent and wound around its short edge. An edge wound winding provides greater current carrying capacity due to the increase in surface area in comparison to a thin wire, however there is a limit to the size of material that can be edge wound in this manner. Edge wound coils are therefore generally not suited for high powered devices which carry high currents.

In many electrical circuits, it is necessary to provide a common mode choke in order to suppress unwanted common mode currents (i.e. noise). A common mode choke is a type of inductor in which opposing windings (choke coils) are wound about a magnetic core and connected to the supply line and ground. The choke coils work as an ordinary wire against differential mode current (i.e. signal) whilst working as an inductor against common mode current. For common mode current, the current is conducted on all lines in the same direction. As a result of the opposite windings of the choke coils, the magnetic flux generated in the core from each coil flows in the same direction and aggregates. The choke coils therefore present a high impedance to the flow of common mode current therefore acting to suppress it so that unwanted high frequency noise in the circuit is substantially eliminated.

Generally, in the design of power electronic systems, a balance must be struck between cost, electrical performance and manufacturability. For a common mode choke for example, the coils must be sized to adequately carry the currents, the core must have a sufficient cross-sectional area to obtain the desired magnetic flux density, the overall volume of package space should be minimised insofar as possible, and heat dissipation and manufacturability should be optimised. It would be desirable to minimise the size of the core required for a given system.

It would be advantageous to provide a common mode choke which optimises a number of these variables in a more effective manner than known devices.

It is against this background, and the problems and difficulties associated therewith, that the present invention has been developed.

### SUMMARY OF THE PRESENT INVENTION

In one broad form, an aspect of the present invention seeks to provide a coil assembly, the coil assembly including a plurality of substantially planar plates interconnected to define a plurality of electrically conductive windings for surrounding a magnetic core.

In one embodiment, successive windings are laterally spaced apart by spacer elements.

In one embodiment, the spacer elements are at least one of: formed integrally with each plate; and, separate elements inserted between adjacent plates.

In one embodiment, the spacer elements are one of: an electrical conductor; and, an electrical insulator.

In one embodiment, each of a plurality of the substantially planar plates have a similar or identical geometric shape.

In one embodiment, the substantially planar plates are generally U-shaped.

In one embodiment, the U-shaped plates defining successive windings are rotationally offset.

In one embodiment, the U-shaped plates of successive windings are rotationally offset by 90 degrees.

In one embodiment, the U-shaped plates are interconnected at joints, the joints of successive windings being rotationally offset.

In one embodiment, each joint includes a conductive spacer element sandwiched between successive plates.

In one embodiment, the substantially planar plates are generally L-shaped.

In one embodiment, bolt holes extend through opposing ends of the L-shaped plates so that one or more through bolts may be inserted through the entire assembly.

In one embodiment, one end of the plate has a raised surface for adjoining with and providing an electrical pathway between successive plates of the winding.

In one embodiment, the raised surface is formed by folding over an end of the plate.

In one embodiment, an insulated spacer element is provided between successive plates of the windings, the insulated spacer element having the same thickness as the raised surface.

In one embodiment, one or more of the plates are deformed so that end portions thereof are positioned in spaced apart planar relation to each other.

In one embodiment, one or more of the plates are deformed as a result of spacer elements being wedged in between successive windings.

In one embodiment, successive plates of the winding are interconnected by at least one of: soldering; brazing; bonding; and, mechanical fasteners.

In one embodiment, the thickness of each plate is at least one of: greater than 1 mm; greater than 2 mm; less than 20 mm; less than 10 mm; and, approximately 5 mm.

In one embodiment, each plate has a width of at least one of: greater than 10 mm; greater than 20 mm; less than 50 mm; less than 40 mm; and, approximately 30 mm.

In one embodiment, each plate has a cross-sectional area of at least one: between 100 to 200 mm²; between 120 to 180 mm²; between 130 to 170 mm²; between 140 to 160 mm²; and, approximately 150 mm².

In one embodiment, the coil assembly is built up around a leg of the core.

In another broad form, an aspect of the present invention seeks to provide a magnetic core assembly, including: a magnetic core; and, at least two coil assemblies, the coil assemblies each including a plurality of substantially planar plates interconnected to define a plurality of electrically conductive windings for surrounding the magnetic core.

In one embodiment, the at least two coil assemblies are built up around legs of the core.

In one embodiment, the at least two coil assemblies have the same number of windings.

In one embodiment, the at least two coil assemblies are wound in opposite directions about the core.

In one embodiment, the magnetic core assembly is for use as a common mode choke that suppresses common mode current in an electrical circuit.

In a further broad form, an aspect of the present invention seeks to provide a common mode choke for suppressing common mode current in an electrical circuit, the common mode choke including: a magnetic core; a first coil assembly, the first coil assembly including a plurality of substantially planar plates interconnected to define a plurality of electrically conductive windings for surrounding the magnetic core; and, a second coil assembly, the second coil assembly including a plurality of substantially planar plates interconnected to define a plurality of electrically conductive windings for surrounding the magnetic core, the number of windings of the first and second coil assemblies being equal and the windings of the second coil assembly being wound about the core in an opposite direction to the windings of the first coil assembly; wherein, as common mode currents flow through the windings of each coil assembly, magnetic flux is accumulated in the core producing impedance to suppress the common mode current.

In one embodiment, the magnetic core and first and second coil assemblies are at least one of: set in a potting compound; and immersed in an oil bath.

In one embodiment, the potting compound is a thermally conductive material that assists in extracting heat away from the choke.

In one embodiment, a plurality of cooling tubes are positioned in close proximity to the coil assemblies and at least partially surrounding the core for extracting heat away from the choke.

In yet a further broad form, an aspect of the present invention seeks to provide a method of assembling a coil, the method including interconnecting a plurality of substantially planar plates so as to define a plurality of electrically conductive windings for surrounding a magnetic core.

In one embodiment, the method includes assembling the coil around the core.

In one embodiment, the plates are connected by joints and the method includes: applying solder paste onto joint surfaces; and, heating the solder paste to form the joints.

In one embodiment, the method includes heating the solder paste using at least one of: a heat gun; a gas gun; and, an oven.

In one embodiment, the method includes brazing or bonding the joints.

In one embodiment, the method includes mechanically fastening the joints.

In one embodiment, the method includes inserting spacer elements between the plates.

In one embodiment, the spacer elements form part of the joints.

In one embodiment, the plates are laser cut and/or bent from sheet metal to form substantially planar plates having a similar or identical geometric shape.

In one embodiment, the plates are generally U-shaped or L-shaped plates. Other shapes are also contemplated such as C-shaped plates and arcuate curved plates.

In one embodiment, successive plates of the winding are selectively oriented and arranged about the core.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which:—

FIG. 1A is a perspective view of an example of a coil assembly;

FIG. 1B is a plan view of the coil assembly of FIG. 1A;

FIG. 1C is an exploded view of the coil assembly of FIG. 1A;

FIG. 1D is a side view of the coil assembly of FIG. 1A;

FIG. 2A is a perspective view of a magnetic core assembly including the coil assembly of FIG. 1A and an oppositely wound coil assembly;

FIG. 2B is a plan view of the magnetic core assembly of FIG. 2A;

FIG. 2C is a side view of the magnetic core assembly of FIG. 2A;

FIG. 3A is a perspective view of an example of a common mode choke;

FIG. 3B is a perspective view of the common mode choke of FIG. 3A with an external potted cover removed to show the internal liquid cooling tubes;

FIG. 3C is an end view of the common mode choke as shown in FIG. 3B;

FIG. 4A is an end view of a second example of a coil assembly;

FIG. 4B is a plan view of an L-shaped plate used in the coil assembly of FIG. 4A;

FIG. 4C is a side view of the coil assembly of FIG. 4A;

FIG. 5 is a side view of a third example of a coil assembly; and,

FIG. 6 is a side view of a fourth example of a coil assembly.

### DETAILED DESCRIPTION OF THE PREFERRED EMBODIMENTS

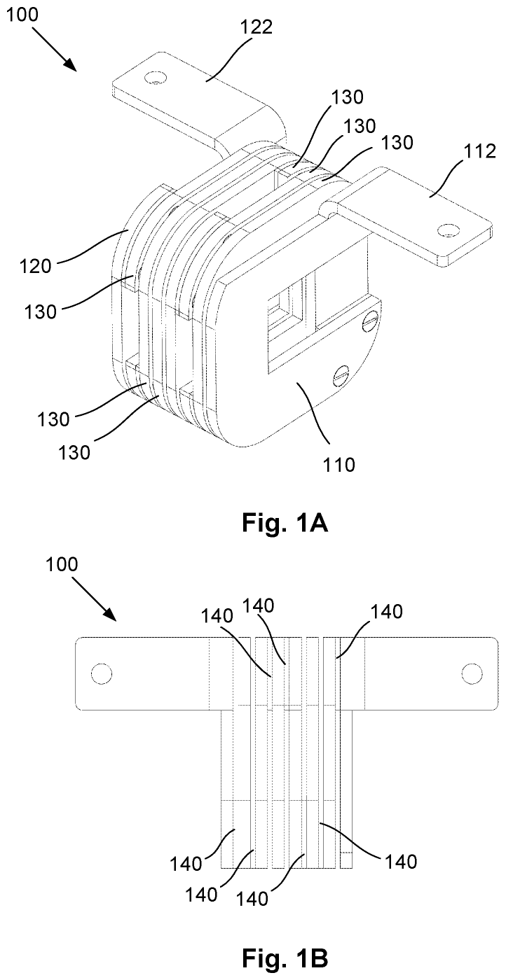

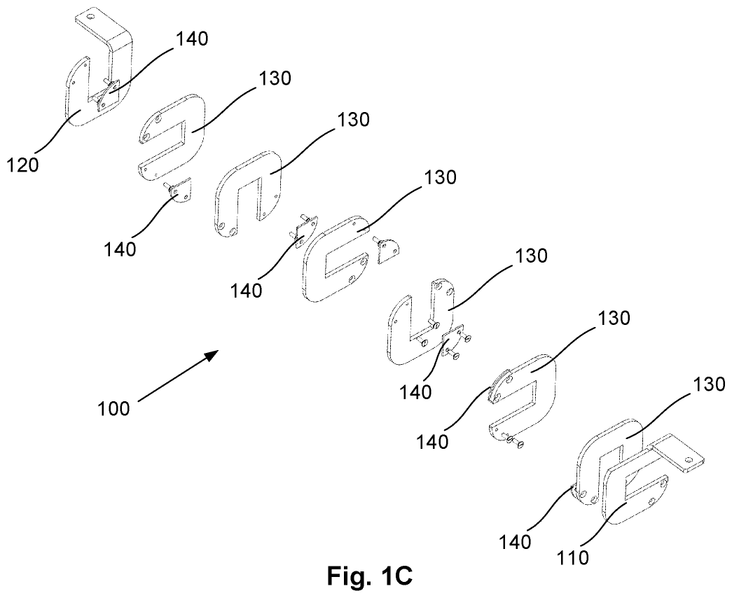

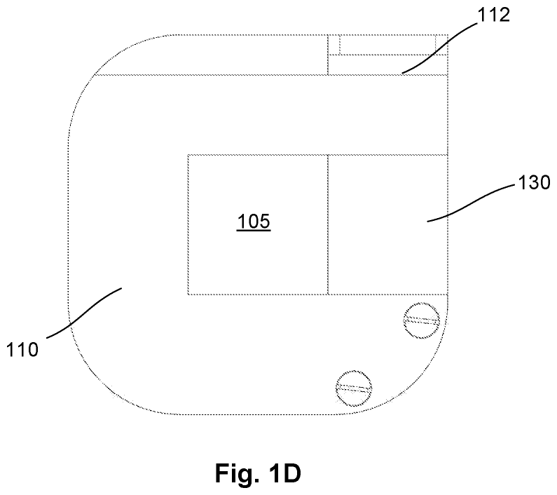

An example of a coil assembly 100 will now be described with reference to FIGS. 1A to 1D. Whilst not limited to such, in an exemplary example the coil assembly 100 is for use in a common mode choke, although it may also find application in other types of inductors, transformer and power magnetic devices.

In this example, the coil assembly 100 includes a plurality of substantially planar plates 110, 120, 130 interconnected to define a plurality of electrically conductive windings for surrounding a magnetic core (not shown). In other words, the winding is not continuous and instead is formed by joining together a number of discrete plate-like elements which once assembled form a winding around the core for carrying electrical current.

It is to be appreciated that substantially planar plates do not need to be completely planar and may have one or more thin raised sections or a slight bend or twist along a direction of elongation. It will be understood further that the plates can be formed from any suitable geometric shape so long as they are suitable for assembly around a core.

This novel construction methodology provides a number of advantages.

Firstly, it permits a coil or winding to be formed which has a large cross sectional area thereby making the suitable for carrying high currents (e.g. 350-500 A (Amps)) in high power systems (e.g. 150-350 kW (kilowatts)). Significantly higher current carrying capacity can be obtained from this arrangement compared to an edge wound coil for example which has limits on the width of coil that is able to be wound (i.e. bend radius limitations).

The packing density of the conductive material (typically copper) is also increased compared to a similarly rated coil made for example from large diameter wire. As a result of the efficiency gain in packing density, a smaller core can also be used to achieve the same magnetic flux density. This leads to a smaller overall packaging size for a magnetic core assembly using the above described coil and reduces overall material cost.

Furthermore, each plate of the winding has a slot or opening that allows the plates to be built up around a leg of the core which may assist in achieving optimal utilisation of space as compared to a traditional wound coil.

A number of further features shall now be described.

Typically, successive windings are laterally spaced apart by spacer elements. Whilst the spacer elements may be separate elements inserted between adjacent plates, in other examples the spacers may be formed integrally with each plate in the form of a raised boss-like section, which can be formed for example by folding over an end of the plate.

In some examples, the spacer elements act as an electrical conductor and allow current to flow between portions of adjacent plates whilst at the same time spacing the plates apart in other areas so as to prevent a short circuit in the coil. Any suitably conductive material such as copper may be used for these spacers. In other examples, the spacer elements act as an electrical insulator and may be made for example from a suitable insulative material including plastics such as nylon, acrylic, silicone etc. These spacers would be used to provide spacing and insulation between successive windings.

As previously mentioned, the plates may take any suitable geometric shape that allows them to be built up around the core. In this regard, typically, each of a plurality of the substantially planar plates have a similar or identical geometric shape for ease of manufacture and assembly. In one example, the substantially planar plates are generally U-shaped. These plates define a slot or channel which permits them to be arranged around the core leg.

When U-shaped plates are used for each winding, the plates defining successive windings are rotationally offset (typically by 90 degrees). This staggered arrangement of plates in the winding allows a continuous electrical pathway to be formed once all of the plates are interconnected.

Typically, the U-shaped plates are interconnected at joints and the joints of successive windings are also rotationally offset. In this regard, the joint in each layer of the winding moves between corner regions between the plates in a particular direction of rotation, dependent on the direction of the winding.

In this example, each joint includes a conductive spacer element sandwiched between successive plates. The spacer element is contoured to fit in a respective corner region between plates in successive windings and provide electrical connection between plates whilst at the same time spacing adjacent plates laterally in regions away from the joint.

In other arrangements, the substantially planar plates are generally L-shaped. L-shaped plates may provide the advantage of being able to fit around a greater range of core geometries, including cores having a thickness/width that is not compatible with a U-shaped plate.

Typically, bolt holes extend through opposing ends of the L-shaped plates so that one or more through bolts may be inserted through the entire assembly. This arrangement is advantageous as it reduces the amount of joint surfaces that require soldering, brazing, bonding or mechanical fastening.

In one example, one end of the plate has a raised surface for adjoining with and providing an electrical pathway between successive plates of the winding, which in one example can be formed from a folded end of the plate. When a plate of this construction is used, an insulated spacer element is provided between successive plates of the windings, the insulated spacer element having the same thickness as the raised surface of the plate and positioned in opposing relation thereto.

In yet a further example, one or more of the plates are deformed so that end portions thereof are positioned in spaced apart planar relation to each other. For example, the plates may be bent or twisted lengthwise so that the necessary spacing is achieved between successive plates that are joined to form the winding. One or more of the plates may be deformed as a result of spacer elements being wedged in between successive windings. These spacers would be insulated and would enable the use of through bolts to connect the entire assembly as previously described.

Typically, successive plates of the winding are interconnected at the joints by at least one of soldering, brazing, bonding and mechanical fasteners. In one example, each joint in the assembly is assembled using solder paste with a gas torch or heat gun (or optionally baking in an oven) to melt the solder paste. Alternatively, and/or in addition the joint may be secured using mechanical fasteners such as screws.

In one example, the thickness of the plates is at least one of: greater than 1 mm, greater than 2 mm, less than 20 mm, less than 10 mm and approximately 5 mm. Furthermore, each plate typically has a width of at least one of: greater than 10 mm, greater than 20 mm, less than 50 mm, less than 40 mm and approximately 30 mm.

In further examples, the plates have a cross-sectional area of at least one: between 100 to 200 mm², between 120 to 180 mm², between 130 to 170 mm², between 140 to 160 mm², and, approximately 150 mm². These are non-limiting examples of suitable cross-sectional areas for carrying a high current in the order of 350 to 500 A, although it will be appreciated that other cross sectional areas could be used for carrying different currents.

It will be appreciated that in the previously described examples, the coil assembly is capable of being built up around a leg of the core which is advantageous as this method of assembly allows packaging volume to be optimised and smaller cores to be used.

Typically, a magnetic core assembly is provided, including a magnetic core; and, at least two coil assemblies, the coil assemblies each including a plurality of substantially planar plates interconnected to define a plurality of electrically conductive windings for surrounding the magnetic core. A magnetic core assembly with improved electrical performance can therefore be provided, including an assembly having a high current carrying capacity, increased copper packing density and a smaller core to achieve a required magnetic flux density.

In one example, the at least two coil assemblies have the same number of windings and are wound in opposite directions about the core. Such an arrangement is suitable for a common mode choke for suppressing common mode current (i.e. noise) in an electrical circuit.

Accordingly, in one broad form, there is provided a common mode choke for suppressing common mode current in an electrical circuit, the common mode choke including: a magnetic core; a first coil assembly, the first coil assembly including a plurality of substantially planar plates interconnected to define a plurality of electrically conductive windings for surrounding the magnetic core; and, a second coil assembly, the second coil assembly including a plurality of substantially planar plates interconnected to define a plurality of electrically conductive windings for surrounding the magnetic core, the number of windings of the first and second coil assemblies being equal and the windings of the second coil assembly being wound about the core in an opposite direction to the windings of the first coil assembly; wherein, as common mode currents flow through the windings of each coil assembly, magnetic flux is accumulated in the core producing impedance to suppress the common mode current.

In one example, the magnetic core and first and second coil assemblies are set in a potting compound which is a thermally conductive material (for example a resin) that assists in extracting heat away from the choke. Alternatively, the core and coil assemblies may be immersed in an oil bath which is used to extract heat away from the choke. Optionally or additionally, the choke may be liquid cooled via a plurality of cooling tubes that are positioned in close proximity to the coil assemblies and at least partially surrounding the core for extracting heat away from the choke.

In another broad form, there is provided a method of assembling a coil, the method including interconnecting a plurality of substantially planar plates so as to define a plurality of electrically conductive windings for surrounding a magnetic core.

Advantageously, the method may include assembling the coil around a leg of the core as previously described.

Typically, the plates are connected by joints and in one example the method includes applying solder paste onto joint surfaces and heating the solder past to form the joints. In this regard, the solder paste may be heated using a heat gun, gas torch or be baked in an oven. The joints may also be mechanically fastened using screws or the like which are typically countersunk so the head is flush with the plate surface. Alternative methods of assembly may also be used including for example brazing or bonding the joints together.

The method also typically includes inserting spacer elements between the plates so as to achieve the necessary lateral spacing. In some examples, the spacer elements form part of the joints (when they are conductive), although in other examples the spacers may not form part of the joints (and instead be made from an insulative material).

In manufacture, the plates are typically laser cut and/or bent from sheet metal to form substantially planar plates having a similar or identical geometric shape. In one example, the plates are generally U-shaped or L-shaped, although other shapes are also contemplated including C-shaped and arcuate or curved plates. In one example, the plates are laser cut and one end of the plate is folded to form a spacer.

During assembly, successive plates of the winding are selectively oriented and arranged about the core. For example, in the case of U-shaped plates, successive plates are oriented at 90 degrees to a previous plate before being arranged about the core.

Referring again to FIGS. 1A to 1D, the coil assembly 100 shall now be described in further detail. The coil assembly includes a first end plate 110 that is substantially U-shaped having a base and a pair of legs extending from the base. The end plate 110 provides a terminal 112 in the form of a bent over lip for electrical interconnection with a line. An end plate 120 is provided on the opposite side of the assembly and having a terminal 222. A plurality of U-shaped plates 130 are then arranged between the end plates 120, 130 so as to define a plurality of electrical windings. Each successive U-shaped plate is rotationally offset 90 degrees with respect to the previous plate in the stack so that a continuous electrical pathway is formed. A plurality of conductive spacer elements 140 are positioned between each adjacent plate in corner regions therefore for facilitating an electrical joint between plates whilst at the same time ensuring that non-conductive areas of the plates remain spaced apart so as not to short circuit the coil. The spacer elements 140 are typically copper and may be approximately 2 mm in thickness.

In this arrangement, the spacer elements 140 between successive plates are rotationally offset and move in a direction of rotation between corner regions of adjacent plates. To create the interconnection, a solder paste is applied to each joint surface (to the spacer or plate) and then a heat gun or gas torch is typically used to melt the solder. Fasteners such as screws may also be used to secure each joint as shown in FIG. 1C for example. In this example, the screws can be recessed so that they are flush with the surface of the plate, although this is not essential and other fastener arrangements could be used. It will be appreciated that other forms of securing the joints may be used such as brazing or bonding the joints.

The plate elements themselves are typically laser cut from sheet metal although any suitable cutting or forming method may be used to form the desired shape. In this regard, the plate element can be shaped to conform to an outer surface of the core, for example by providing square internal corners, which can help minimise separation between the core and coil, which is not typically achievable using a traditional winding. Furthermore, the plates can include curved outer corners, which maintains a constant cross sectional area for current flow through the winding, whilst minimising the overall volume of the resulting device.

As shown in FIG. 1D, the assembled coil 100 includes a window 105 for receiving a leg of the core when the coil is built up around the core.

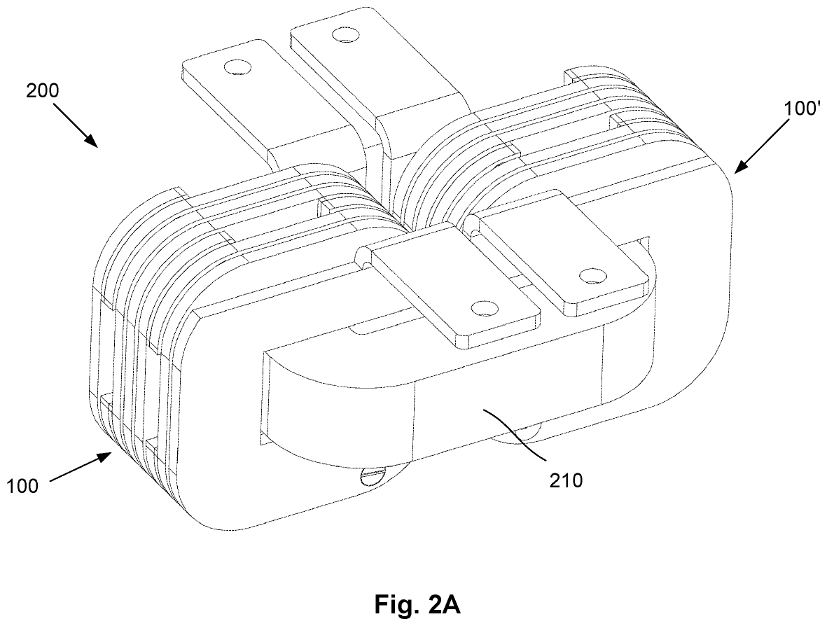

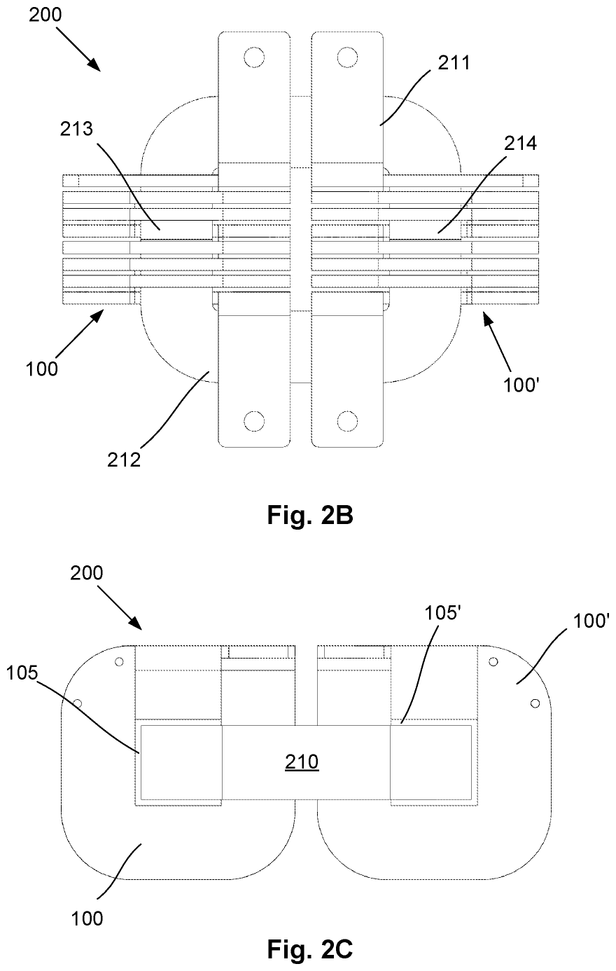

In FIGS. 2A to 2C, there is shown a magnetic core assembly 200 including a core 210 (in this example a U or C core) around which coil assemblies 100 and 100′ are arranged. The core 210 may be a nano-crystalline core. The core 200 in this example has yokes 211, 212 and limbs or legs 213, 214 about which the respective coil assemblies are wound. Leg 213 of core 200 is positioned within the window 105 of coil assembly 100, whilst leg 214 of core 200 is positioned within window 105′ of coil assembly 100′. The coil assembly 100′ is oppositely wound to coil assembly 100 and is effectively a mirrored assembly. The number of windings in each coil assembly is the same and such an arrangement is of particular use in a common mode choke.

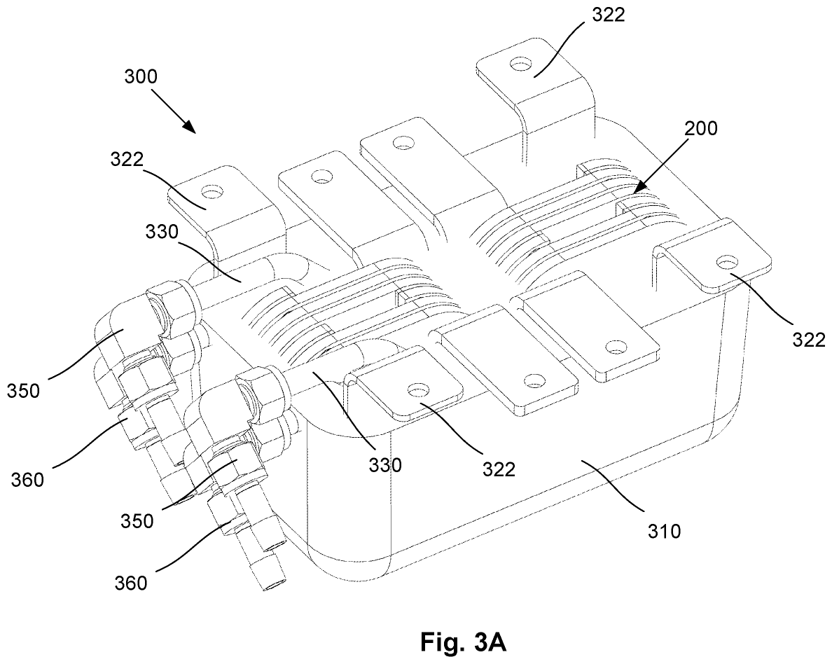

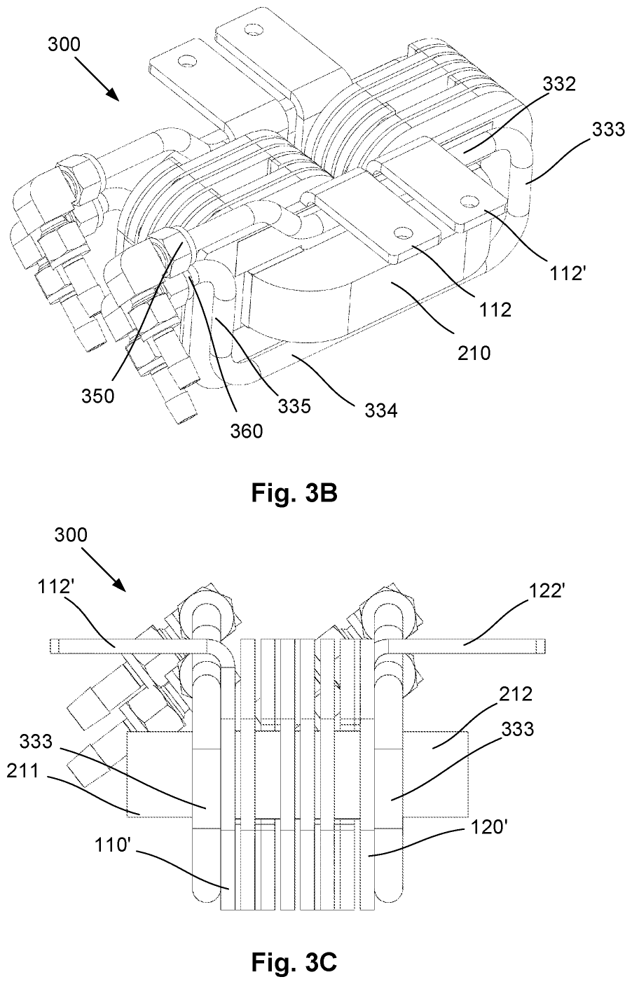

A common mode choke 300 incorporating the magnetic core assembly 200 is shown in FIGS. 3A to 3C. The magnetic core assembly 200 is set in a potting compound forming a thermally conductive resin cover 310. The potting compound flows all around the coil assemblies and core and provides further electrical insulation. Any suitable thermally conductive material may be used and resin is one non-limiting example. In other arrangements, the magnetic ore assembly may be immersed in an oil bath or other arrangement suitable for extracting heat away from the choke. The common mode choke 300 further includes a pair of side mounting plates having feet or pads 322 which enable the choke to be mounted via these attachment points to a base structure. Insulating sheets (not shown) are also typically provided around the core and coil assemblies.

The common mode choke 300 also has a cooling system which is provided by a plurality of cooling tubes 330 (typically aluminium-diameter approximately 10 mm) that re-circulate a coolant through the choke 300 via inlet/outlet hose connectors 350, 360. The cooling tubes 330 are housed within the potted cover 310 and are routed in close proximity to the ends of the coil assemblies 100, 100′ and at least partially around the core 210. The cooling tubes 330 enter the housing via inlet connector 350 and tube segment 332 extends above the core 210 and below the terminals 112, 112′. The tube then bends down via segment 333 and returns back to outlet 360 via a path below the core 210 defined by tube segments 334, 335. Heat dissipated by the choke 300 is extracted by the thermally conductive potting compound 310 and pulled towards the cooling tubes 330 that allow the heat to be dissipated.

In operation, on the input side, the supply and ground lines are connected to terminals 112, 112′ of the respective coil assemblies 100, 100′ and on the output side, the load is connected to terminals 322, 322′. As common mode current flows in the same direction on the supply and ground lines, the respective coil assemblies 100, 100′ will magnetise the core and magnetic flux will be caused to flow around the core 210 in the same direction. The flux therefore accumulates and a high amount of impedance is produced which suppresses the common mode current so that the load does not see the unwanted high frequency noise. For differential mode current (the signal) which flows in opposite directions on the supply and ground lines, the magnetic flux produced in the core 210 will be in opposite direction and will cancel each other out. This results in very low impedance so that the signal and direct currents will pass to the load.

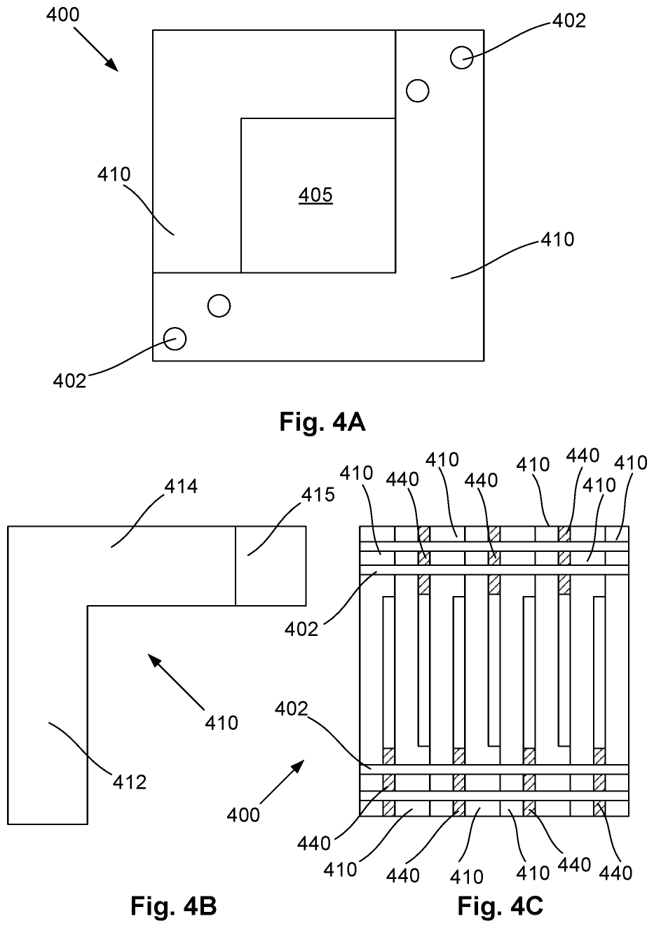

In FIGS. 4A to 6, alternative coil constructions are disclosed. In FIGS. 4A to 4C, a plurality of L-shaped plates 410 are used to form a coil assembly 400. A similar window 405 is formed by this construction method, with the advantage that the open L-shaped plate is able to fit around cores of thickness that U-shaped plates might not be able to. In this example, each L-shaped plate has limbs 412, 414 and at the end of limb 414 is a raised portion 415 for forming an electrically conductive joint with an adjacent plate. The assembly 400 is best shown in FIG. 4C in which it can be seen that plastic or insulated spacers 440 are also positioned between adjacent plates opposite the raised portions 415 of the plates 410. It will be appreciated that the spacers 440 have equal thickness to the raised portions 415. Such an assembly allows one or more through bolts 402 to extend through the entire assembly and a further advantage of this arrangement is that less joints requiring soldering, brazing, bonding and mechanically fastening are in the assembly which may provide a cost benefit as well as faster assembly time.

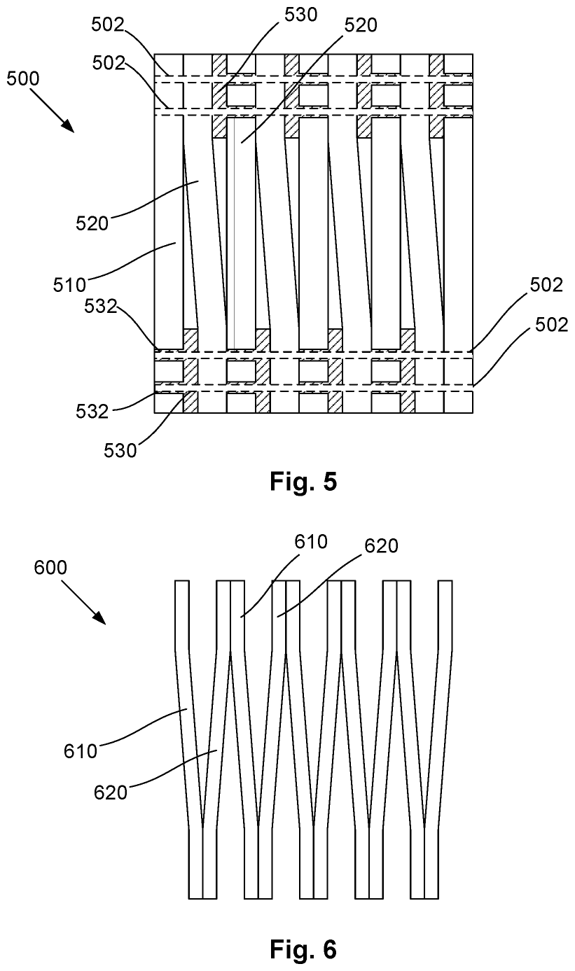

In FIGS. 5 and 6, there are shown examples where one or more plates in the respective coil assemblies 500, 600 are at least partially deformed. In coil assembly 500, there are straight L-plates 510 that are joined to deformed L-plates 520, said plates deformed by wedging an insulated spacer 530 therebetween. Each spacer 530 may have cylindrical protrusions 532 which locate in bolt holes of plates 510 and like the previous example long through bolts 502 may extend through the entire coil. In coil assembly 600, the plates 610, 620 are pre-deformed (bent lightly out of plane) and interconnected via a plurality of solder joints at opposing ends of successive windings.

Accordingly, in at least one example, there is provided an improved coil assembly that increases packing density of conductive material such as copper and allows sufficient cross-sectional areas of winding to be achieved for carrying high currents in the order of 350 to 500 A. This arrangement allows a corresponding magnetic core size about which the coil is wound to be reduced while maintaining a desired magnetic flux density. Furthermore, the coil construction permits the coil to be built up around a leg of the core so that overall packaging volume can be optimised. The novel coil winding is particularly useful for a common mode choke that may have application for example in a high power electric vehicle (EV) charging unit.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A coil assembly, the coil assembly including a plurality of substantially planar plates interconnected to define a plurality of electrically conductive windings for surrounding a magnetic core.

2) The coil assembly according to claim 1, wherein successive windings are laterally spaced apart by spacer elements.

3) The coil assembly according to claim 2, wherein the spacer elements are at least one of:
a) formed integrally with each plate; and,
b) separate elements inserted between adjacent plates.

4) The coil assembly according to claim 3, wherein the spacer elements are one of:
a) an electrical conductor; and,
b) an electrical insulator.

5) The coil assembly according to any one of the preceding claims, wherein each of a plurality of the substantially planar plates have a similar or identical geometric shape.

6) The coil assembly according to claim 5, wherein the substantially planar plates are generally U-shaped.

7) The coil assembly according to claim 6, wherein the U-shaped plates defining successive windings are rotationally offset.

8) The coil assembly according to claim 7, wherein the U-shaped plates of successive windings are rotationally offset by 90 degrees.

9) The coil assembly according to any one of claims 6 to 8, wherein the U-shaped plates are interconnected at joints, the joints of successive windings being rotationally offset.

10) The coil assembly according to claim 9, wherein each joint includes a conductive spacer element sandwiched between successive plates.

11) The coil assembly according to any one claims 1 to 5, wherein the substantially planar plates are generally L-shaped.

12) The coil assembly according to claim 11, wherein bolt holes extend through opposing ends of the L-shaped plates so that one or more through bolts may be inserted through the entire assembly.

13) The coil assembly according to any one of the claims 1 to 12, wherein one end of the plate has a raised surface for adjoining with and providing an electrical pathway between successive plates of the winding.

14) The coil assembly according to claim 13, wherein the raised surface is formed by folding over an end of the plate.

15) The coil assembly according to claim 13 or claim 14, wherein an insulated spacer element is provided between successive plates of the windings, the insulated spacer element having the same thickness as the raised surface.

16) The coil assembly according to any one of the claims 1 to 15, wherein one or more of the plates are deformed so that end portions thereof are positioned in spaced apart planar relation to each other.

17) The coil assembly according to claim 16, wherein one or more of the plates are deformed as a result of spacer elements being wedged in between successive windings.

18) The coil assembly according to any one of the claims 1 to 17, wherein successive plates of the winding are interconnected by at least one of:
a) soldering;
b) brazing;
c) bonding; and,
d) mechanical fasteners.

19) The coil assembly according to any one of claims 1 to 18, wherein the thickness of each plate is at least one of:
a) greater than 1 mm;
b) greater than 2 mm;
c) less than 20 mm;
d) less than 10 mm; and,
e) approximately 5 mm.

20) The coil assembly according to any one of the claims 1 to 19, wherein each plate has a width of at least one of:
a) greater than 10 mm;
b) greater than 20 mm;
c) less than 50 mm;
d) less than 40 mm; and,
e) approximately 30 mm.

21) The coil assembly according to any one of claims 1 to 20, wherein each plate has a cross-sectional area of at least one:
a) between 100 to 200 mm²;
b) between 120 to 180 mm²;
c) between 130 to 170 mm²;
d) between 140 to 160 mm²; and,
e) approximately 150 mm².

22) The coil assembly according to any one of the preceding claims, wherein the coil assembly is built up around a leg of the core.

23) A magnetic core assembly, including:
a) a magnetic core; and,
b) at least two coil assemblies, the coil assemblies each including a plurality of substantially planar plates interconnected to define a plurality of electrically conductive windings for surrounding the magnetic core.

24) The magnetic core assembly according to claim 23, wherein the at least two coil assemblies are built up around legs of the core.

25) The magnetic core assembly according to claim 23 or claim 24, wherein the at least two coil assemblies have the same number of windings.

26) The magnetic core assembly according to claim 25, wherein the at least two coil assemblies are wound in opposite directions about the core.

27) The magnetic core assembly according to claim 26, for use as a common mode choke that suppresses common mode current in an electrical circuit.

28) A common mode choke for suppressing common mode current in an electrical circuit, the common mode choke including:
a) a magnetic core;
b) a first coil assembly, the first coil assembly including a plurality of substantially planar plates interconnected to define a plurality of electrically conductive windings for surrounding the magnetic core; and,
c) a second coil assembly, the second coil assembly including a plurality of substantially planar plates interconnected to define a plurality of electrically conductive windings for surrounding the magnetic core, the number of windings of the first and second coil assemblies being equal and the windings of the second coil assembly being wound about the core in an opposite direction to the windings of the first coil assembly;
wherein, as common mode currents flow through the windings of each coil assembly, magnetic flux is accumulated in the core producing impedance to suppress the common mode current.

29) The common mode choke according to claim 28, wherein the magnetic core and first and second coil assemblies are at least one of:
a) set in a potting compound;
b) immersed in an oil bath.

30) The common mode choke according to claim 29, wherein the potting compound is a thermally conductive material that assists in extracting heat away from the choke.

31) The common mode choke according to claim 30, wherein a plurality of cooling tubes are positioned in close proximity to the coil assemblies and at least partially surrounding the core for extracting heat away from the choke.

32) A method of assembling a coil, the method including interconnecting a plurality of substantially planar plates so as to define a plurality of electrically conductive windings for surrounding a magnetic core.

33) The method according to claim 32, wherein the method includes assembling the coil around the core.

34) The method according to claim 32 or claim 33, wherein the plates are connected by joints and the method includes:
a) applying solder paste onto joint surfaces; and,
b) heating the solder paste to form the joints.

35) The method according to claim 34, wherein the method includes heating the solder paste using at least one of:
a) a heat gun;
b) a gas torch; and,
c) an oven.

36) The method according to claim 32 or claim 33, wherein the method includes brazing or bonding the joints.

37) The method according to any one of claims 34 to 36, wherein the method includes mechanically fastening the joints.

38) The method according to any one of claims 32 to 37, wherein the method includes inserting spacer elements between the plates.

39) The method according to claim 38, wherein the spacer elements form part of the joints.

40) The method according to any one of claims 32 to 39, wherein the plates are laser cut and/or bent from sheet metal to form substantially planar plates having a similar or identical geometric shape.

41) The method according to claim 40, wherein the plates are generally U-shaped or L-shaped.

42) The method according to any one of claims 32 to 41, wherein successive plates of the winding are selectively oriented and arranged about the core.
